(19) United States
(12) Patent Application Publication
(10) Pub. No.: US 2025/0157181 A1
(43) Pub. Date: May 15, 2025

(54) AI-POWERED HAIR COLORING FORMULATION

(71) Applicant: Color Coach LLC, Pinehurst, TX (US)

(72) Inventors: Stephanie Wilson, Pinehurst, TX (US); Patricia Smith, Magnolia, TX (US)

(21) Appl. No.: 18/506,568

(22) Filed: Nov. 10, 2023

(51) Int. Cl. G06V 10/72; A61Q 5/10

(52) U.S. Cl. CPC G06V 10/72; A61Q 5/10

(57) ABSTRACT

An online system accesses a database that stores information on hair coloring products from multiple brands. Users upload an image of their current hair condition and specify a desired hair condition. A machine-learning model assesses various hair attributes, such as current shade, tone, texture, and porosity level, based on the uploaded image. The system employs a decision tree based model to analyze these attributes that characterize the current hair condition with the desired hair condition to determine a hair color treatment. Based on the hair color treatment, the system determines a specific hair coloring formulation, including products from one or more brands, the ratio between these products, and the application time required to achieve the desired hair condition. This formulation is then displayed on the user's device.

### BACKGROUND

This disclosure relates generally to color-matching software and more specifically a color-matching software application for determining hair color formulation.

Formulating hair color is a complex process that involves scientific, technical, and aesthetic considerations. In particular, the condition, texture, and existing color treatments of the hair present variables that can affect the final color outcome, complicating the choice of colorants and application techniques. Thicker, denser hair may require more product and longer processing time to achieve the desired result. The natural level of hair and percentage of gray hair are some of the significant factors in determining color choices. Hair that has undergone chemical treatments like perming, straightening, or prior coloring can have different porosity levels, which requires an adjustment to the hair color formula. For example, high porosity needs extra gold tone to be added into the formula or the hair can look green or an undesired tone.

Additionally, each natural level of hair has a different underlying pigment. Understanding the underlying pigments associated with each natural hair level is crucial as these pigments can react differently to added colors. Also, as each underlying pigment is identified, they all require a different shade choice for each desired look. This is one of the most challenging parts of deciding on hair color formula choice. Each desired look requires not only a different color additive, but also a precise mixing ratio. If these underlying pigments are not properly identified or considered, the final color could end up looking brassy or ashy. Further, timing is crucial; the duration of the color left on the hair can significantly impact the final shade. For example, different product types, services, and application styles may require varying amounts of time to achieve the desired results.

Before applying a new hair color treatment to the entire head of hair, a strand test may be performed to gauge the hair's response to the product. However, this test can be time-consuming and may not perfectly predict the final outcome when applied to the entire head of hair.

### SUMMARY

Embodiments described herein solve the above-described problem by using a pretrained AI model. In some embodiments, an online system maintains a database storing information about hair coloring products from a plurality of brands. The online system receives input data from a client device (e.g., a user device). The input data includes an image of hair before applying coloring products. The online system accesses a machine-learning model trained to output values of one or more attributes that characterize hair conditions based on images of hair. The one or more attributes include (but are not limited to) a current shade of hair, a tone of hair, a texture of hair, a porosity level of hair, a natural shade of hair, and/or a percent of gray. The machine-learning model is applied to the image of hair to output values of the one or more attributes that characterize current hair condition.

In some embodiments, the input data also includes a desired hair condition. The online system applies a decision-tree-based model to the values of the one or more attributes that characterize the current hair condition and the desired hair condition. It then outputs a hair color treatment to be applied to the current hair. The hair color treatment may include (but is not limited to) a level of shade indicating how much a shade of the current hair needs to be darkened or lightened, and/or a level of tone indicating how much a tone of the current hair needs to be changed. Next, the online system identifies a hair coloring formulation based on this treatment. The formulation includes one or more hair coloring products from at least one of the plurality of brands. It also specifies a ratio between the products, as well as a time period for which a mixture of these products should be applied to achieve the hair color treatment that causes the hair to transit from the current condition to the desired hair condition. Finally, the system presents the hair coloring formulation on the client device.

### BRIEF DESCRIPTION OF THE DRAWINGS

FIG. 1 is a block diagram of a system environment in which an online system, such as an online hair color formulation system, in accordance with one or more embodiments.

FIG. 2 illustrates an example online system, such as an online hair color formulation system, in accordance with one or more embodiments.

FIG. 3A illustrates an example machine learning process to train a machine-learning model for determining a current hair condition based on an image of hair, in accordance with one or more embodiments.

FIG. 3B illustrates an example machine learning process to train a machine-learning model for determining a hair coloring treatment based on a current hair condition and a desired hair condition, in accordance with one or more embodiments.

FIG. 3C illustrates an example process of using a decision tree based model to determine a hair color formulation based on a current hair condition and a desired hair condition, in accordance with one or more embodiments.

FIG. 4A is a diagram of a customer mobile application for a customer to interact with an online hair color formulation system, in accordance with one or more embodiments.

FIG. 4B is a diagram of a hairstylist mobile application for a hairstylist to interact with an online hair color formulation system, in accordance with one or more embodiments.

FIG. 5 is a flowchart of one embodiment of a method of using a machine-learning model to determine a hair color formulation, in accordance with one or more embodiments.

FIG. 6A illustrates an example home interface of a mobile application, in accordance with one or more embodiments.

FIG. 6B illustrates an example interface of a color translator of a mobile application, in accordance with one or more embodiments.

FIG. 6C illustrates an example interface of a mobile application listing a list of permanent brands, in accordance with one or more embodiments.

FIGS. 6D-1 through 6D-5 illustrate example interfaces of a mobile application that allow a user to make a sequence of selections to obtain a permanent shade coloring product offered by a particular brand, in accordance with one or more embodiments.

FIG. 6E illustrates an example interface of a mobile application listing a list of demi-permanent brands, in accordance with one or more embodiments.

FIGS. 6F-1 through 6F-5 illustrate example interfaces of a mobile application that allow a user to make a sequence of selections to obtain a demi-permanent shade coloring product offered by a particular brand, in accordance with one or more embodiments.

FIGS. 6G-1 through 6G-5 illustrate example interfaces of a mobile application that allow users to select services, and input information based on the selected services, in accordance with one or more embodiments.

FIGS. 6H-1 through 6H-2 illustrate example interfaces of a mobile application for a user to input a desired hair condition, in accordance with one or more embodiments.

FIG. 6H-3 illustrates an example interface of a mobile application that displays a hair color formulation based on user input of current hair condition and desired hair condition, in accordance with one or more embodiments.

FIG. 7 is a block diagram illustrating components of an example machine able to read instructions from a machine-readable medium and execute them in a processor (or controller).

The figures depict embodiments of the present disclosure for purposes of illustration only. One skilled in the art will readily recognize from the following description that alternative embodiments of the structures and methods illustrated herein may be employed without departing from the principles, or benefits touted, of the disclosure described herein.

### DETAILED DESCRIPTION

### System Architecture

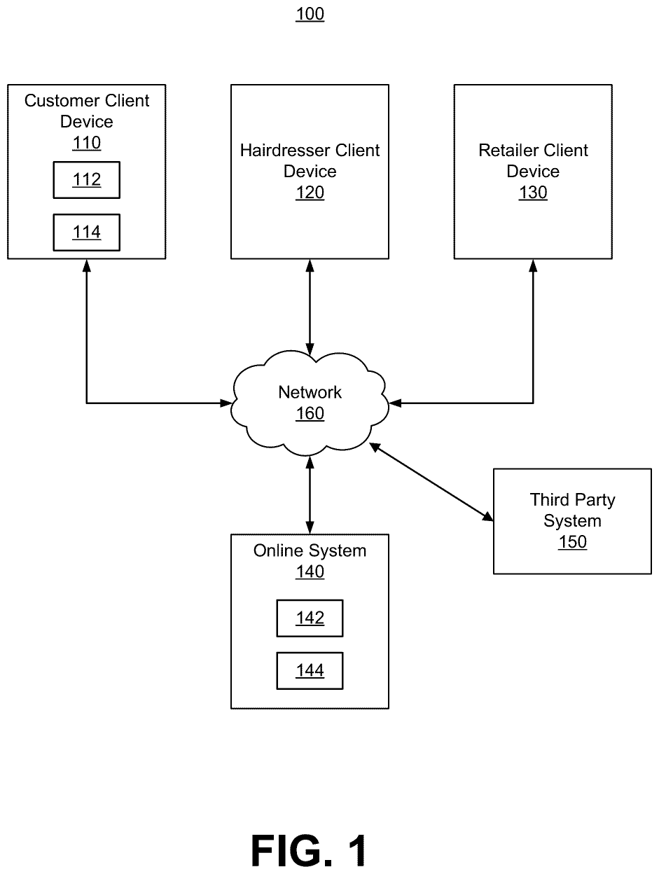

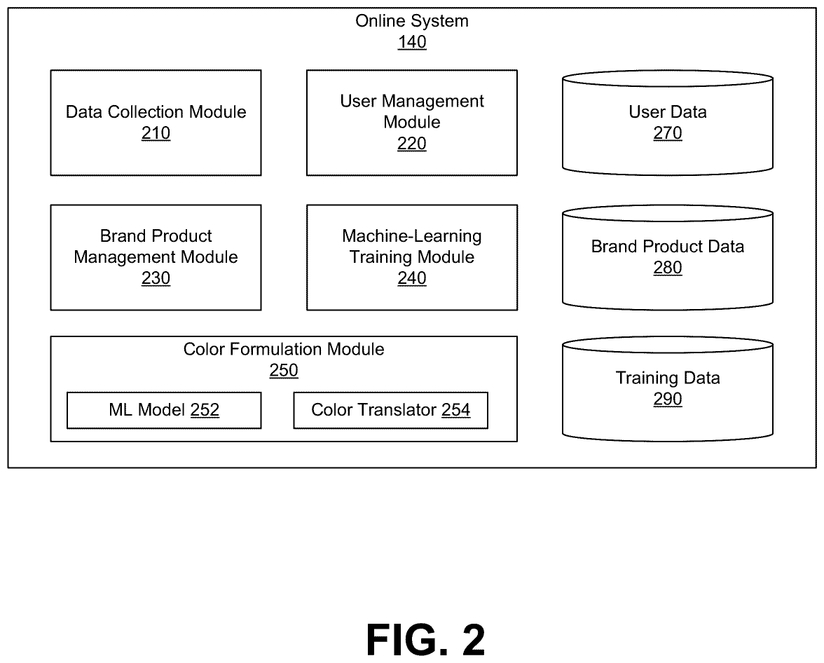

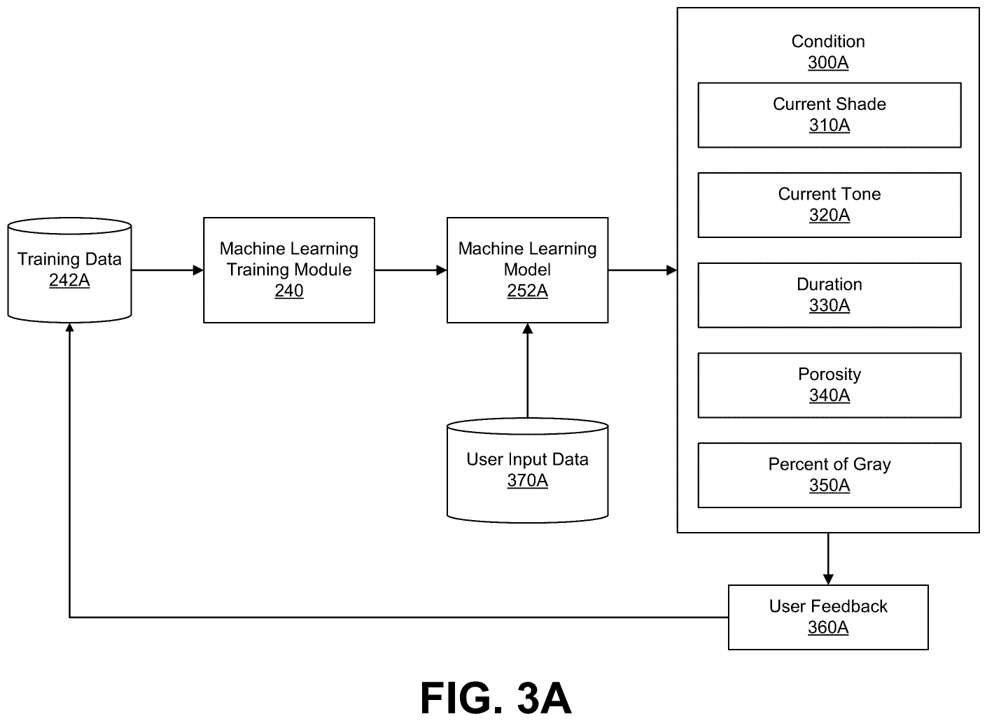

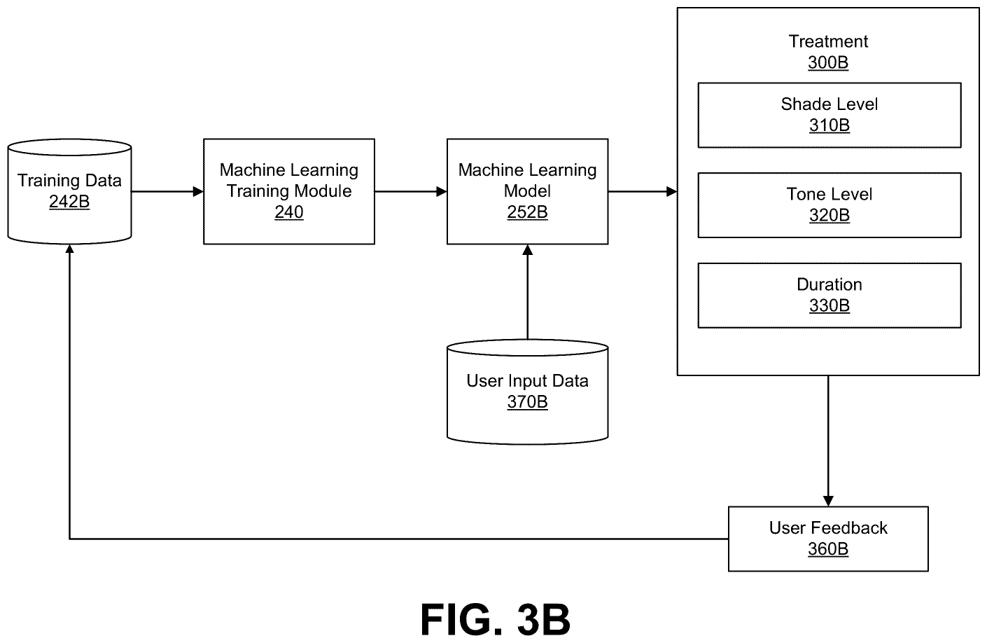

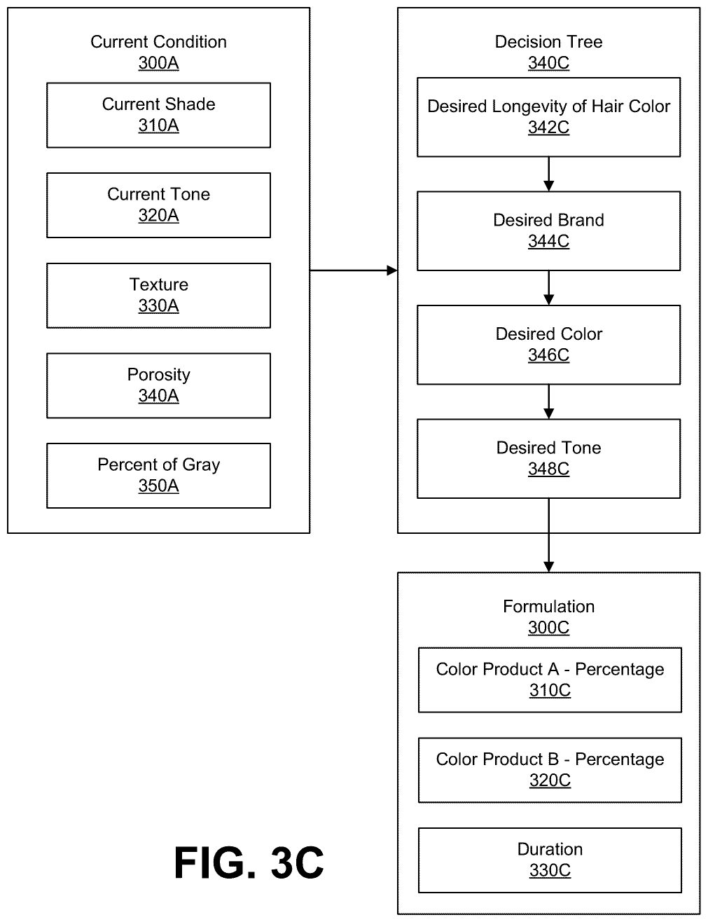

FIG. 1 is a block diagram of a system environment 100 in which an online system 140, such as an online hair color formulation system as further described below in conjunction with FIGS. 2 and 3, operates. The system environment 100 shown by FIG. 1 comprises one or more client devices 110, 120, 130, a network 160, one or more third party systems 150, and the online hair color formulation system 140. In alternative configurations, different and/or additional components may be included in the system environment 100. In some embodiments, the client devices may include one or more customer client devices 110, each associated with a customer who is interested in a hair color treatment. In some embodiments, the client devices may include one or more hairstylist client devices 120, each associated with a hairstylist who performs hair color treatments for customers. In some embodiments, the client devices may include one or more retailer client devices 130, which may be placed at a retail location (e.g., near hair color products) or at a hair salon, and accessible by customers and/or hairstylists.

The client devices 110, 120, 130 are one or more computing devices capable of receiving user input as well as transmitting and/or receiving data via the network 160. In one embodiment, a client device 110, 120, or 130 is a computer system, such as a desktop or a laptop computer. Alternatively, a client device 110, 120, or 130 may be a device having computer functionality, such as a personal digital assistant (PDA), a mobile telephone, a smartphone, or another suitable device. Alternatively, a client device 130 may be a kiosk, a terminal, or a scanner.

A client device 110, 120, 130 is configured to communicate with the online hair color formulation system 140 or other devices via the network 160. In one embodiment, a client device 110, 120, 130 executes an application allowing a user of the client device 110, 120, 130 to interact with the online hair color formulation system 140. For example, the customer client device 110 executes a customer mobile application, and the hairstylist client device 120 executes a hairstylist mobile application, as further described below, to enable interaction between the client device 110, 120 and the online hair color formulation system 140. As another example, a client device 110, 120, 130 executes a browser application to enable interaction between the client device 110 and the online hair color formulation system 140 via the network 160. In another embodiment, a client device 110, 120, 130 interacts with the online hair color formulation system 140 through an application programming interface (API) running on a native operating system of the client device 110, such as IOS® or ANDROID™.

A client device 110, 120, or 130 includes one or more processors 112 configured to control operation of the client device 110 by performing functions. In various embodiments, a customer client device 110 includes a memory 114 comprising a non-transitory storage medium on which instructions are encoded. The memory 114 may have instructions encoded thereon that, when executed by the processor 112, cause the processor to perform functions to execute the customer mobile application to provide the functions further described below. Similarly, a hairstylist client device 120 or a retailer client device 130 also includes one or more processors and a memory (not shown). The memory may have instructions encoded thereon that, when executed by the one or more processors, cause the one or more processors to perform functions to execute a respective hairstylist mobile application or a retailer application.

The client devices 110, 120, 130 are configured to communicate via the network 160, which may comprise any combination of local area and/or wide area networks, using both wired and/or wireless communication systems. In one embodiment, the network 160 uses standard communications technologies and/or protocols. For example, the network 160 includes communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via the network 160 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 160 may be represented using any suitable format, such as hypertext markup language (HTML) or extensible markup language (XML). In some embodiments, all or some of the communication links of the network 160 may be encrypted using any suitable technique or techniques.

One or more third party systems 150 may be coupled to the network 160 for communicating with the online hair color formulation system 140 or with the one or more client devices 110. In one embodiment, a third party system 150 is an application provider communicating information describing applications for execution by a client device 110, 120, 130 or communicating data to client devices 110, 120, 130 for use by an application executing on the client device. In other embodiments, a third party system 150 provides content or other information for presentation via a client device 110, 120, 130. For example, the third party system 150 stores one or more web pages and transmits the web pages to a client device 110, 120, 130 or to the online hair color formulation system 140. The third party system 150 may also communicate information to the online hair color formulation system 140, such as advertisements, content, or information about an application provided by the third party system 150. In some embodiments, the third party systems 150 may be associated with different brands of hair color products.

The online hair color formulation system 140 includes one or more processors 142 configured to control operation of the online hair color formulation system 140 by performing functions. In various embodiments, the online hair color formulation system 140 includes a memory 144 comprising a non-transitory storage medium on which instructions are encoded. The memory 144 may have instructions encoded thereon corresponding to the modules further below in conjunction with FIG. 3 that, when executed by the processor 142, cause the processor to perform the functionality further described above in conjunction with FIGS. 2-4.

For example, the memory 144 has instructions encoded thereon that, when executed by the processor 142, cause the processor 142 to maintain a database storing information about hair coloring products from a plurality of brands, and receive input data from a client device. The input data includes (1) an image of current hair and (2) a desired hair condition after applying one or more color products of at least one of the plurality of brands. The processor 142 is also caused to access a machine-learning model trained to output values of one or more attributes that characterize hair condition based on images of hair. The one or more attributes include at least a shade of hair and a tone of hair. The processor 142 is also caused to apply the machine-learning model to the image of hair to output values of of the one or more attributes that characterize the current hair condition, and applies a decision tree based model to the values of the one or more attributes that characterize the current hair condition and the specified hair condition to output a hair color treatment that is to be applied to the current hair. In some embodiments, the hair color treatment may include a level of shade and/or a level of tone that is to be applied to the hair to cause the current hair to transition from the current hair condition to the desired hair condition. The processor 142 is also caused to identify a hair coloring formulation based on the hair color treatment. The hair coloring formulation includes one or more hair coloring products from at least one of the plurality of brands, along with a ratio between the one or more hair coloring products, and a time period for which a mixture of the one or more hair coloring products is to be applied to the hair to cause the hair to transition from the current condition to the desired hair condition. The processor 142 then causes the hair coloring formulation to be presented on the client device.

Additionally, the online hair color formulation system 140 includes a communication interface configured to connect the online hair color formulation system 140 to one or more networks, such as network 160, or to otherwise communicate with devices (e.g., client devices 110, 120, 130) connected to the one or more networks.

One or more of a client device 110, 120, 130, a third party system 150, or the online hair color formulation system 140 may be special purpose computing devices configured to perform specific functions, as further described below in conjunction with FIGS. 2-5, and may include specific computing components such as processors, memories, communication interfaces, and/or the like.

### System Overview

FIG. 2 illustrates an example online system, such as an online hair color formulation system 140, in accordance with one or more embodiments. The figures use like reference numerals to identify like elements. The online hair color formulation system 140 includes a data collection module 210, a user management module 220, a brand product management module 230, a machine-learning training model 240, and a color formulation module 250. The online hair color formulation system 140 also includes or has access to various databases that store various data, such as (but not limited to) user data 270, brand product data 280, and training data 290.

User data 270 includes a variety of information collected from or about users through their interaction with the online hair color formulation system 140. Users may include (but are not limited to) customers, hairstylists, and/or brand representatives. User data 270 may include usernames or user IDs, password hashes, security questions and answers, account creation and last login dates, etc. User data 270 may also include user behavioral data, such as links clicked, search queries, and interactions with user interface elements. User data 270 may include personal identification information, such as name, email address, physical address, phone number, date of birth, etc. User data 270 may also include transactional data, such as purchase history, payment information, shipping and billing addresses, order status and tracking information, etc. User data 270 may also include IP addresses, device information (e.g., metadata about types of devices, operating systems, browsers), cookies and session IDs, geolocation data, etc. User data 270 may also include social media profiles, social media interactions and behavior, and/or friend lists, etc. User data 270 may also include user-generated content (such as reviews, comments, photos), and user preferences (such as saved items, and wish lists). User data 270 may also include communication data, such as messages exchanged with customer service, feedback, and reviews. User data 270 may also include preferences and settings, such as language, notification preferences, privacy settings, bank account details, credit/debit card information, or other digital wallet information.

Brand product data 280 includes a shade and/or a tone of each hair coloring product. In some embodiments, the brand product data 280 may also include (but are not limited to) product name, product ID/SKU, category and sub-category, brand name, product description, features and specifications, material composition, retail price, wholesale price, discounts, and offers, stock levels, release and discontinuation dates, and instructions for users. Brand product data 280 may also include visual elements, such as product images, videos, 3D models, etc.

Training data 290 may include (but is not limited to) images of hairs and their corresponding conditions. Such images may be captured and labeled by hairstylists and/or customers. In some embodiments, such images are labeled by a pre-trained machine-learning model and later confirmed or rejected by users.

The data collection module 210 is configured to collect data from users, such as (but not limited to) customers, hairstylists, and/or brand representatives. The user management module 220 is configured to manage those different users, such as (but not limited to) customers, hairstylists, and brand representatives. In some embodiments, the user management module 220 is configured to analyze user interactions and data throughout user lifecycles to help improve the satisfaction of users, assist in user retention, and drive sales growth.

The brand product management module 230 is configured to manage different products offered by different brands. This module may allow brand representatives to manage their product portfolio more effectively. In some embodiments, each brand may include its own product catalog, and its brand representatives may be allowed to add and/or remove products from the catalog, and/or store and/or update product details, such as descriptions, images, and specifications. The module may also allow a new brand to be set up, or an existing brand to be removed. In some embodiments, this module may also allow organizations to manage promotional activities such as discounts, bundle offers, and/or loyalty programs. In some embodiments, this module is also configured to analyze popularity of products of different brands, and track user satisfaction associated with different products or different brands.

The machine-learning training module 240 is configured to train one or more machine-learning models based on data collected from users. In some embodiments, a machine-learning model is trained to receive information describing a person's current hair condition (e.g., an image of the person's current hair), and generate values of one or more attributes that describe characteristics of the current hair condition. The one or more attributes of the user's current hair condition may include (but are not limited to) a current shade, a current tone, a texture of hair, a porous level of hair, a percentage of gray, etc. In some embodiments, the machine-learning model is a convolutional neural network (CNN).

In some embodiments, multiple models are trained to determine multiple attributes associated with the user's hair conditions. Alternatively, a single model is trained to determine the user's hair condition as a vector, including a set of values. For example, a CNN may be trained to classify an image for both gray percentage and level. In some embodiments, the images are preprocessed before training. For example, the images may be converted to Hue, Saturation, and Lightness (HSL) to de-emphasize brightness affected by lighting and then use adaptive histogram equalization (CLAHE) to enhance contrast.

In some embodiments, a machine-learning model is trained to receive a current hair condition and a desired hair condition as input and generate a hair color treatment as output. For example, values of one or more attributes that characterize the current hair condition may be input by a user, or determined by the machine-learning model described above. The desired hair condition may include (but is not limited to) a desired shade and a desired tone. The hair color treatment may include a level of shade indicating how much a shade of the current hair needs to be darkened or lightened, and/or a level of tone indicating how much a tone of the current hair needs to be changed.

In some embodiments, a machine-learning model is trained to receive a current hair condition, a desired hair condition, and a particular brand as input and generate a hair color formulation as output. Again, the input of this machine-learning model may be obtained from user directly, or from output of another machine-learning model. The hair color formulation includes a mixture of different shades and tones with specific ratios along with a duration for applying the mixture to hair.

In some embodiments, the images or other input data are obtained from a mobile application installed at a client device 110, 120, 130 as user feedback to enable the machine-learning training module 240 to perform supervised reinforcement training of the model.

The pretrained or retrained machine learning models 252 are made available to the color formulation module 250. The color formulation module 250 is configured to receive input of a user's current hair condition and a desired hair condition and apply the machine-learning model 252 to the input, causing the machine-learning model(s) 252 to generate output. The output may include attribute values associated with the current hair condition of the user, a color treatment, and/or a color formulation for a particular brand.

In some embodiments, the color formulation module 250 applies a decision tree based model on the user input and/or output of other machine-learning models to generate a color formulation for a particular brand. The color formulation module 250 then causes the output of the machine learning model and/or the color formulation to be presented at a client device 110, 120, 130.

In some embodiments, the color formulation module 250 also includes a color translator 254 configured to translate a hair color treatment into products of different brands. In some embodiments, each coloring product of a brand corresponds to a particular shade and a particular tone. In some embodiments, different shades and tones are encoded into numerical values. For example, a color treatment with a shade level of 7 and a tone level of 10 may be represented as 7/10. This color treatment may correspond to a treatment that changes a shade of hair by 7 levels and changes a tone of hair by 10 levels. Responsive to receiving a color treatment (e.g., 7/10) and a brand as input, the color translator 254 is configured to output one or more coloring products of a particular brand. When these products are applied to the user's current hair, they facilitate the specified color treatment to the hair. In some embodiments, the color translator 254 may also output a ratio between the multiple products.

In some embodiments, the color translator 254 also allows a user to input a color formulation, including one or more products of a first brand, and translates the color formulation into a color treatment. In some embodiments, the user can also select a second brand. Upon receiving both the color formulation in the first brand and the selection of the second brand, the color translator 254 is configured to translate the color formulation in the first brand into a color formulation in the second brand, including one or more products of a second brand.

In some embodiments, the color translator 254 is configured to create a first ratio of a first set of shades of a first brand based on a second ratio of a second set of shades of a second brand. As such, the color translator 254 is able to replicate a color treatment without physically weighing and mixing multiple products of different brands and testing the mixture on the hair.

In some embodiments, the color translator 254 uses a pre-trained machine learning model to perform such translation. Alternatively, or in addition, the color translator 254 includes a lookup table that stores values of one or more attributes of multiple coloring products of each brand, and performs the color translation based on the lookup table and/or the pre-trained machine learning model.

### Machine-Learning Models

FIGS. 3A and 3B illustrate example machine learning processes in accordance with one or more embodiments. Those processes enable a machine-learning model 252 to learn from training data 242 without being explicitly programmed. The training data 242A includes labeled datasets. A letter after a reference numeral, such as “242A,” indicates that the text refers specifically to the element having that particular reference numeral. A reference numeral in the text without a following letter, such as “242,” refers to any or all of the elements in the figures bearing that reference numeral. For example, “242” in the text refers to reference numerals “242A” or “242B” in the figures.

Referring to FIG. 3A, in some embodiments, the training data 242A includes images of hair and their corresponding hair conditions. The hair conditions may include (but are not limited to) shades, tones, textures, porosities, and/or percentages of gray. Such hair conditions are encoded into numerical values, such that the machine-learning model 252A can be trained using these numerical values.

The machine-learning model 252A is trained to receive an image of hair as input and determine hair condition 300A as output. The image of hair may user input data 370A received from a client device of a user. The hair condition 300A may include (but is not limited to) a current shade 310A, a current tone 320A, a current texture 330A, a current porosity 340A, and/or a percentage of gray 350A. The machine-learning model 252A encodes the hair condition into a set of values or a vector. For example, each of the shade 310A tone 320A, texture 330A, porosity 340A, and percentage of gray 350A corresponds to a numerical value. Each numerical value may also be associated with a textual description, which is understandable by human readers.

In some embodiments, the machine-learning model 252A is a convolutional neural network (CNN) trained to receive an image of a person's hair as input and determine the person's current hair condition as output. In some embodiments, multiple models are trained to determine multiple attributes associated with the user's hair conditions. Alternatively, a single model is trained to determine the user's hair condition as a vector, including a set of values. For example, a CNN may be trained to classify an image for both gray percentage and shade level. In some embodiments, the images are taken in the mobile app installed on a client device 110, 120, 130 based on user feedback and uploaded back to the online system 140 for supervised reinforcement training of the model. In some embodiments, the images are preprocessed before training. For example, the images may be converted to Hue, Saturation, and Lightness (HSL) to de-emphasize brightness affected by lighting and then use adaptive histogram equalization (CLAHE) to enhance contrast.

In some embodiments, the determined hair condition 300A, which may include the textual description and/or their corresponding numerical values, is sent to a user for review. In some embodiments, the user is able to provide feedback 360A to the determined hair condition 300A. In some embodiments, the user is prompted with a thumb-up or a thumb-down icon to indicate whether the determined hair condition 300A is accurate. Alternatively, or in addition, responsive to determining that the determined hair condition 300A is inaccurate, the user can further input a more accurate hair condition. The user feedback 360A may further be used as additional training data 242A to retrain or finetune the machine-learning model 252A.

In some embodiments, a machine-learning model is trained to receive a current hair condition and a desired hair condition as input and generate a hair treatment as output. FIG. 3B illustrates an example process of training such a machine-learning model. In some embodiments, training data 242B includes current hair condition and desired hair condition pairs, and their corresponding formulations. The training data 242B may be input by users via client devices. For example, hairstylists may visually determine customers' current hair condition, and determine formulations based on the customers' current hair conditions and desired hair conditions. The hairstylists may input such information into the system via hairstylist client devices.

Alternatively, or in addition, the training data 242B may be in part input by users via client devices, and in part determined by the machine-learning model 252A of FIG. 3A. For example, hairstylists may take pictures of their hair, and input the pictures to the machine-learning model 252A, causing the machine-learning model 252A to determine current hair conditions. The hairstylists may then manually determine a hair treatment based on the determined current hair conditions and desired hair conditions, and input the determined hair treatment into the system via the hairstylist client devices.

The machine-learning model 252B is trained to receive a current hair condition and desired hair condition pair as input 370B, and generate a hair color treatment 300B as output. The hair color treatment 300B may include one or more attributes of hair treatment, such as a shade level 310B, a tone level 320B, and/or a duration 330B for applying the level of shade 310A and the level of tone 320B to the hair. In some embodiments, the level of shade indicates how much a shade of the current their needs to be darkened or lightened, and/or the level of tone indicates how much a tone of the current hair needs to be changed.

In some embodiments, users may be able to provide feedback 360B about the determined treatment 300B. In some embodiments, the user is prompted with a thumb-up or a thumb-down icon to indicate whether the determined hair color treatment 300B is accurate. Alternatively, or in addition, responsive to determining that the determined hair color treatment 300B is inaccurate, the user can further input a more accurate treatment. The user feedback 360B may further be used as additional training data 242B to retrain or finetune the machine-learning model 252B.

In some embodiments, after the hair color treatment is determined, the system 140 inputs the hair color treatment into the color translator 254, which in turn generates a hair color formulation based on hair coloring products of a particular brand. In some embodiments, the particular brand may be selected by the online system 140. Alternatively, the particular brand may be selected by a user.

In some embodiments, once the current hair condition 300A is received or determined, the system uses a decision tree based model to determine a hair color formulation. FIG. 3C illustrates an example process of using a decision tree based model to determine a hair color formulation 300C.

A decision tree based model 340C receives the current hair condition 300A, and also receives desired hair condition. The desired hair condition may include several factors, such as desired longevity of hair color 342C, a desired brand 344C, a desired shade or level 346C, and a desired tone 348C. In some embodiments, first, a user is prompted to enter a value for a first factor. The decision tree 340C uses the value of the first factor to limit options for a second factor. After that, the user can select one of the available values for the second factor. Once the value of the second factor is received, the decision tree based model 340C uses the received value of the second factor to limit options for a third factor.

For example, a user is first prompted to enter a desired longevity of hair color 342C. The user may choose permanent shade or demi-permanent shade. As the name suggests, permanent shade refers to permanent colors that will not wash out; demi-permanent shade refers to colors that gradually fade over a period of 12 to 24 shampoos, making it less permanent than permanent shades.

Once the user selects one of the longevity options, the decision tree based model 340C limits the available brands to a subset of brands that offer the selected longevity, and presents the subset of brands for the user to review. The user can then select one of the brand from the subset as a desired brand 344C. Once the user selects the desired brand 344C, the decision tree based model 340C further limits the available color products based on the desired brand 344C, which may also limit the available color and tone that may be achieved by the products of the desired brand 344C. The user is then presented the available resulting colors. After the user selects a desired shade 346C, the decision tree based model 340C may then narrow down the available tones that may be achieved by the available products and consistent with the desired shade, and present the available tones to the user. The user can then select a desired tone 348C from the available tones. The decision tree based model 340C can then generate a hair color formulation 300C based on all the user's selections. The hair formulation 300C may include one or more products and their corresponding percentages or ratios 310C, 320C, and a duration 330C for applying a mixture of the one or more color products to the hair of the user.

Below is an example set of sudo code for the decision tree based model 340C. If the user selects a permanent color, the decision tree based model 340C follows the sudo code associated with the permanent color decisions below; otherwise, the decision tree based model 340C follows the sudo code associated with demi-permanent color decisions below.

### Permanent Color Decisions

Desired level may be the current level and up to 4 levels lighter than the current level.
A desired level will only be displayed if the brand has grey coverage for that given level.
Desired tones are all tones that are available for the desired level in a given brand.
Grey Coverage type is determined by hair texture.
   Coarse:
      Double Pigment if available in the brand, otherwise Neutral.
   Fine, Medium:
      Neutral Grey Coverage
Contributing pigment decision is based on the difference in current and desired level.
If the level stays the same or goes darker then no contributing pigment is needed, otherwise the contributing pigment is the pigment available for the brand and desired level if available.
There are also decisions made around mixing percentages based on the given inputs.

### Demi-Permanent Decisions

Desired Level must always be the same or darker.
Desired Tone has the following decision branching
   If the current tone of the hair is:
      Cool:
      The desired tones available are “Cool”, “Natural Cool”, “Natural”, and
      “Natural Warm”.
      Natural or Warm:
         All tones are available for selection.
      Red:
         The desired tones available are “Natural Red”, “Red”, “Red Red”,
         “Copper Red”, “Violet Red”, and “Violet”.
Pigment Type decision branching
   Branches on current tone
      Cool:
         If the desired tone is “Natural Warm” then a Warm Pigment Type is needed
For any other desired tone no contributing pigment is needed.
   Natural:
      If the desired tone is any of “Natural Red”, “Red”, “Red Red”, or “Copper Red”, then a Warm Pigment Type is needed.
      For any other desired tone no contributing pigment is needed.
   Warm:
      If the desired tone is “Cool”, “Natural”, “Natural Cool”, or “Beige”, then a Cool Pigment Type is needed.
      For any other desired tone no contributing pigment is needed.
   Red:
      No contributing pigment is needed.

### Customer Mobile Application

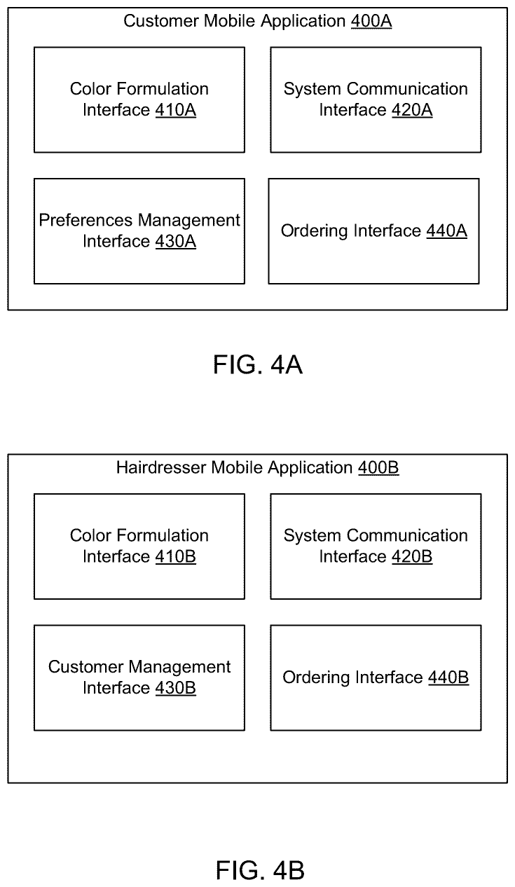

FIG. 4A is a diagram of a customer mobile application 400A, in accordance with one or more embodiments. The customer mobile application 400A may be installed on a customer client device 110. The customer mobile application 400A includes a color formulation interface 410A, a system communication interface 420A, a preference management interface 430A, and an ordering interface 440A. The color formulation interface 410A allows a customer to input their current hair condition and their desired hair condition to receive a hair color formulation from the online system 140. In some embodiments, the color formulation interface 410A allows a customer to take a picture of their hair and upload the picture to the online system 140. The system communication interface 420A enables the customer to communicate with customer service of the online system 140, their hairstylists, and/or representatives of different brands. The preference management interface 430A allows customers to input their preferred brands and products, and other personal preferences, such as preferred communication channels. The ordering interface 440A allows customers to order products via the online system 140 or through brands' systems directly or indirectly.

### Hairstylist Mobile Application

FIG. 4B is a diagram of a hairstylist mobile application 400B, in accordance with one or more embodiments. The hairstylist mobile application 400B may be installed on a hairstylist client device 120. The hairstylist mobile application 400B may also include a color formulation interface 410B, a system communication interface 420B, and an ordering interface 440B, similar to the customer mobile application 400A. In some embodiments, the hairstylist mobile application 400B may also include a customer management interface 430B that allows hairstylists to conveniently manage their customers, including recording the customers' current and desired hair conditions, and brand preference. In some embodiments, the information entered via the hairstylist mobile application 400B may be viewed by corresponding customers via their customer mobile application 400A.

### Example Method of Generating Hair Coloring Formulation

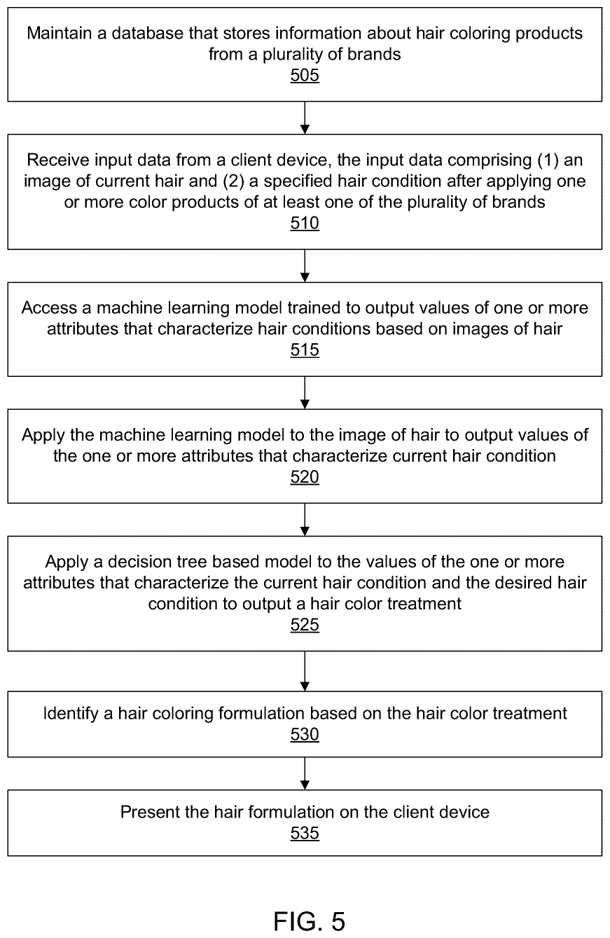

FIG. 5 is a flowchart of one embodiment of a method using a machine-learning model to determine a hair color formulation in accordance with one or more embodiments. In various embodiments, the method includes different or additional steps than those described in conjunction with FIG. 5. Further, in some embodiments, the steps of the method may be performed in different orders than the order described in conjunction with FIG. 5. The method described in conjunction with FIG. 5 may be carried out by the online hair color formulation system 140 in various embodiments, while in other embodiments, the steps of the method are performed by any online system capable of applying or deploying machine learning models.

The online hair color formulation system 140 maintains 505 a database that stores information about hair coloring products from a plurality of brands. The information about each hair coloring product includes a shade and/or a tone of the hair coloring product. In some embodiments, the information may also include (but is not limited to) product name, product ID/SKU, level of shade, level of tone, category and sub-category, brand name, product description, features and specifications, material composition, retail price, wholesale price, discounts, and offers, stock levels, release and discontinuation dates, and instructions for users. Brand product data may also include visual elements, such as product images, videos, 3D models, etc.

The online hair color formulation system 140 receives 510 input data from a client device. The input data includes at least (1) an image of current hair and (2) a desired hair condition after applying one or more color products of at least one of the plurality of brands. In some embodiments, the input data further includes a particular service that the user is to receive or provide, and a particular brand that the user would like to use.

The online hair color formulation system 140 accesses 515 a machine-learning model trained to output values of one or more attributes that characterize hair conditions based on images of hair. The machine-learning model is trained on a training dataset, including labeled hair images, each of which is labeled with values of attributes of hair conditions. Such attributes may include (but are not limited to) shade, tone, texture, porosity, and percentage of gray. The machine-learning model is applied to the training dataset. Parameters of the machine-learning model are modified during the training process to minimize a loss function indicating a difference between a prediction of an image and a label of the image in the training dataset. For a given hair image, the machine-learning model is trained to determine a set of values for a set of attributes associated with hair condition.

The online hair color formulation system 140 applies 520 the machine-learning model to the image of hair to output values of the one or more attributes that characterize the current hair condition. In some embodiments, the online hair color formulation system 140 presents the determined hair condition to the client device. The user of the client device can confirm the determination if they agree with it. Otherwise, the user can make changes. In some embodiments, the online hair color formulation system 140 may capture such user interaction with the AI-made determination, and use such information as additional training examples to retrain or finetune the machine-learning model.

After the current hair condition and desired hair condition are finalized, the online hair color formulation system 140 applies 525 a decision tree based model to the values of the one or more attributes that characterize the current hair condition and the desired hair condition to output a hair color treatment that is to be applied to the hair. The hair color treatment includes a level of shade indicating how much a shade of the current hair needs to be darkened or lightened. Alternatively, or in addition, the hair color treatment includes a level of tone indicating how much a tone of the current hair needs to be changed. For example, the hair color treatment may be 3 shades darker and 5 levels warmer tone.

In some embodiments, the machine-learning model is stored at the online hair color formulation system 140 and applied by the online hair color formulation system 140. Alternatively, the machine-learning model is deployed onto the client device 110, 120, 130, and the client device 110, 120, 130 is caused to apply the machine-learning model. Alternatively, or in addition, some machine-learning models may be applied by the online hair color formulation system 140, and some machine-learning models may be deployed on the client device 110, 120, 130, depending on the client device's processing capability and/or network communication speed, or preference.

The online hair color formulation system 140 identifies 530 a hair coloring formulation based on the hair color treatment. The hair coloring formulation includes one or more hair coloring products from one or more brands among the plurality of brands, along with a ratio between the one or more hair coloring products, and a time period for which a mixture of the one or more hair coloring products is to be applied to the hair to cause the hair to transition from the current condition to the desired hair condition. In some embodiments, the hair coloring formulation also includes a processing solution or a developer. The online hair color formulation system 140 presents 535 the hair formulations on the client device.

In some embodiments, the user can also select a brand from the plurality of brands, and the color formulation is generated based on the selected brand.

### Example Graphical User Interfaces

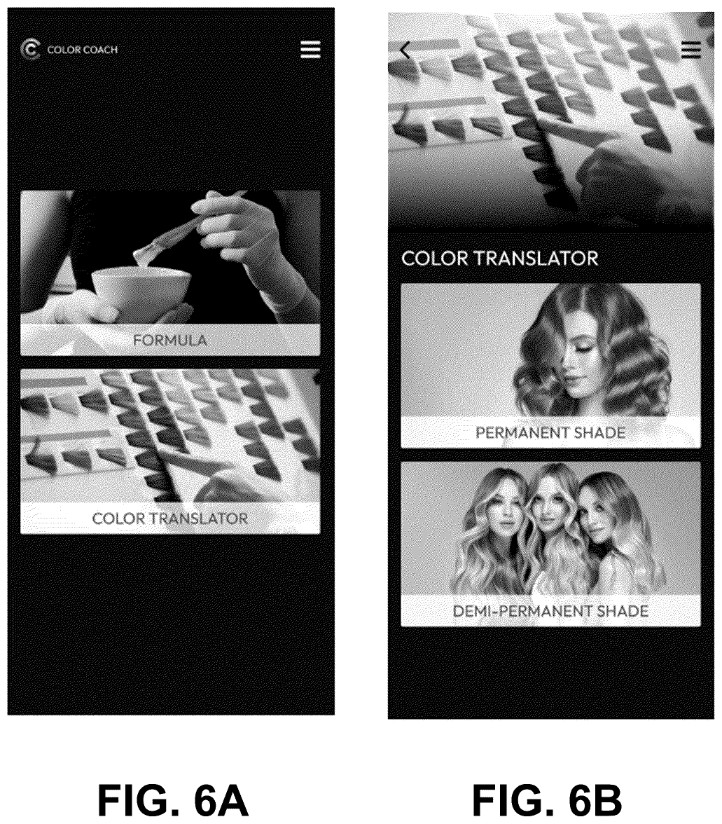

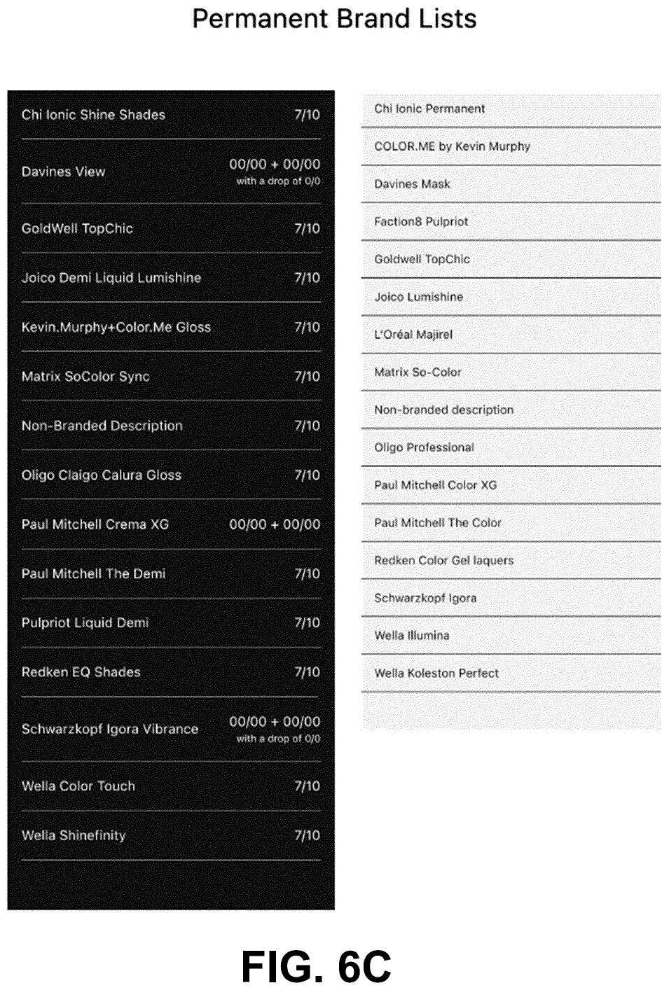

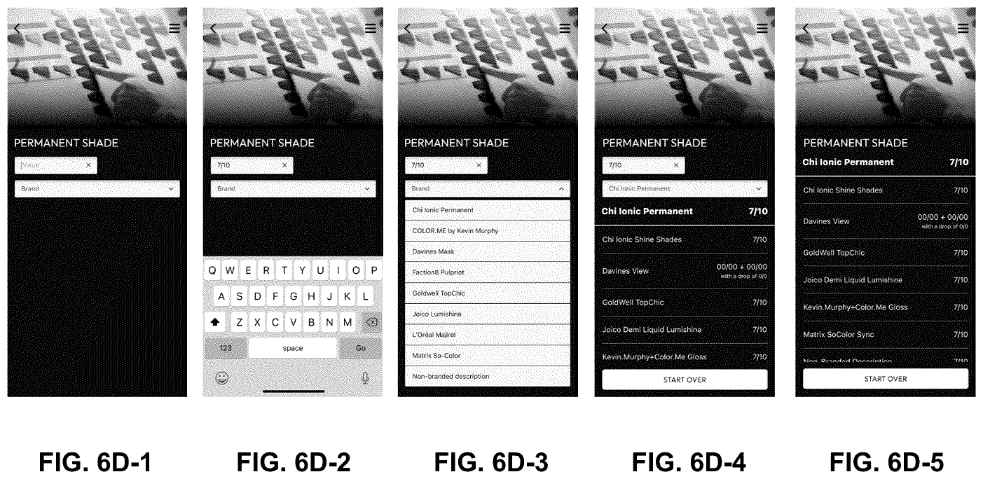

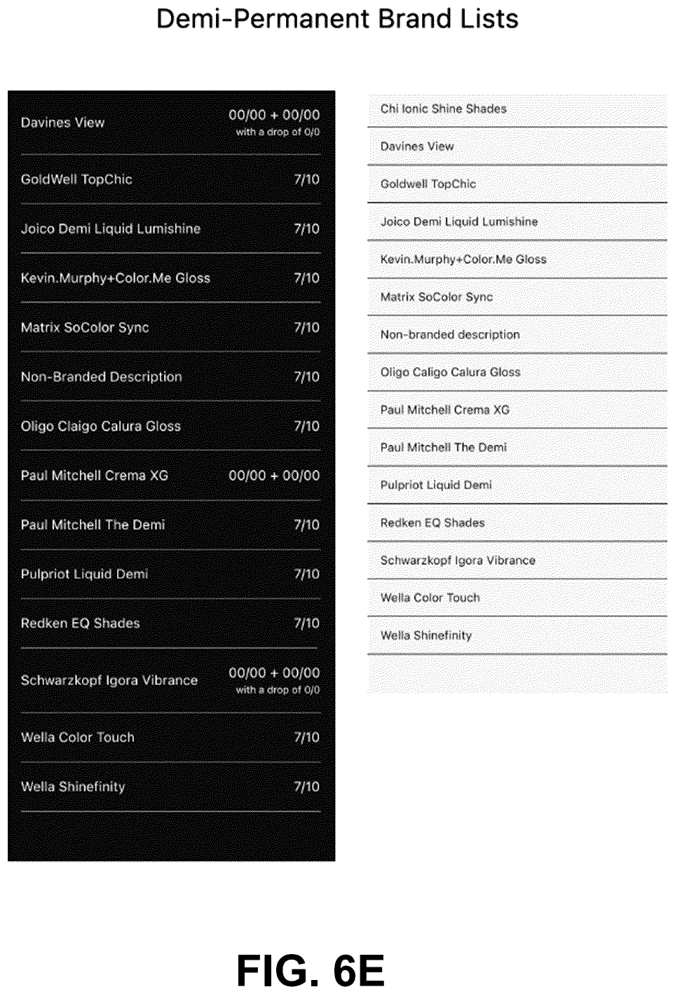

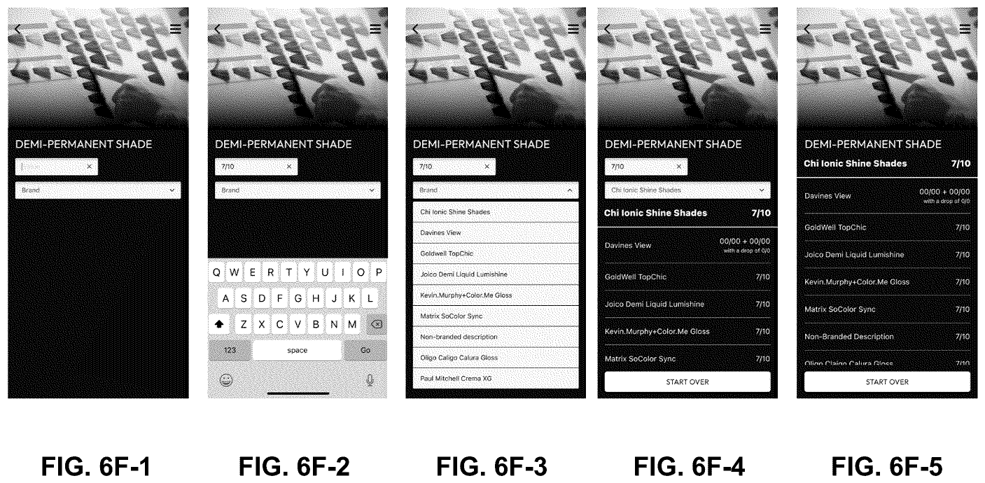

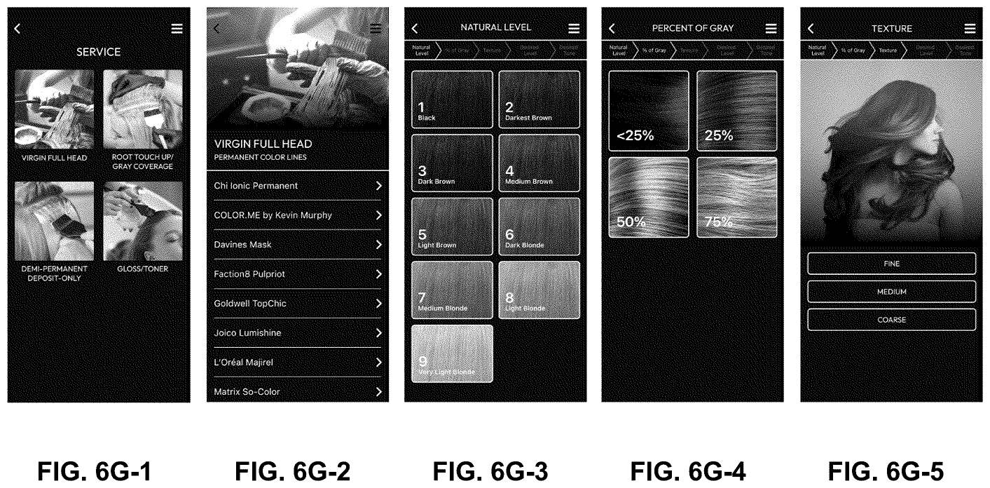

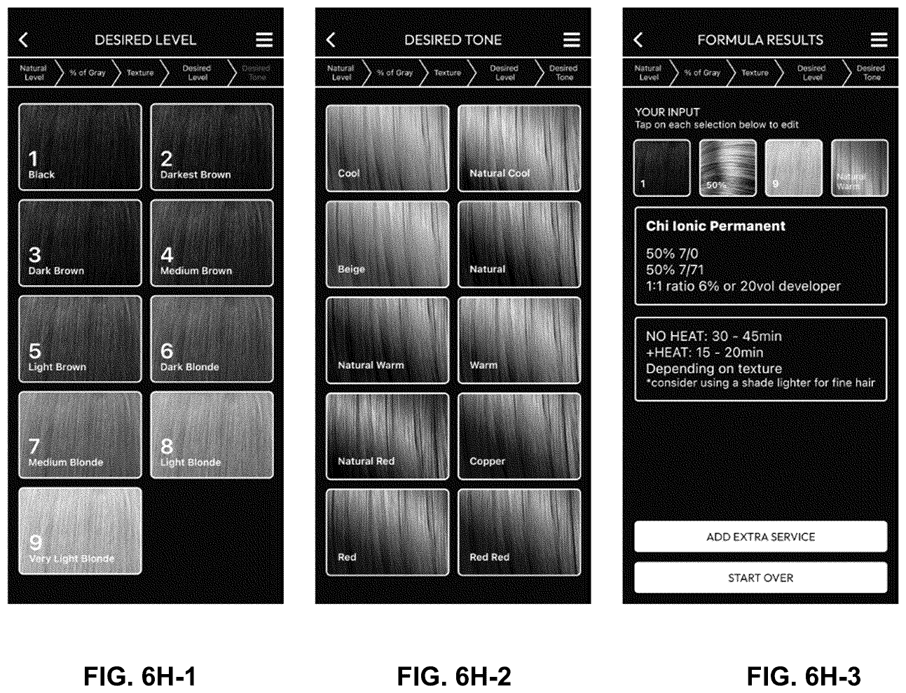

FIGS. 6A-6J-3 illustrate example graphical user interfaces (GUIs) of a customer mobile application 400A or a hairstylist mobile application 400B, in accordance with one or more embodiments.

FIG. 6A illustrates an example home interface of the mobile application 400 in accordance with one or more embodiments. As illustrated, there are two selections, namely, formula and color translator, that a user can select. The formula selection leads to the color formulation function that generates a hair color formulation based on user's input. The color translator leads to the color translation function that translates a color treatment to products of different brands.

FIG. 6B illustrates an example interface of the color translator, in accordance with one or more embodiments. In some embodiments, a user can reach this interface by selecting the “color translator” selection in the home interface of FIG. 6A. In the color translator interface, there are two selections, namely “permanent shade” and “demi-permanent shade,” that a user can select. When a user selects the “permanent shade” selection, a list of brand names that provide permanent shade coloring products is shown. When a user selects the “demi-permanent shade” selection, a list of brand names that provide demi-permanent shade coloring products is shown. Further, through these different selections, a user can input a treatment level and a brand, causing the mobile application 400 to output a color formulation using the coloring products of the input brand.

FIG. 6C illustrates an example interface listing a list of permanent brand lists. FIGS. 6D-1 through 6D-5 illustrate example interfaces that allow a user to make a sequence of selections to obtain a permanent shade coloring product offered by a particular brand. As illustrated in FIGS. 6D-1 and 6D-4, a user inputs a treatment (e.g., 7/10) and a brand name (e.g., Chi Ionic Permanent). The mobile application 400 outputs a list of products of the input brand that provides the input treatment.

Similarly, FIG. 6E illustrates an example interface listing a list of demi-permanent brand lists. FIGS. 6F-1 through 6F-5 illustrate example interfaces that allow a user to make a sequence of selections to obtain a demi-permanent shade coloring product offered by a particular brand.

Further, different hair coloring services may be desired by different people or current hair conditions. In some embodiments, the mobile application 400 allows a user to select one of multiple services. Depending on the selected service, the mobile application presents a different set of prompts for the user to enter additional information.

FIGS. 6G-1 through 6G-5 illustrate example interfaces that allow users to select services, and input information based on the selected services. FIG. 6G-1 shows a list of hair coloring services that a user can select. FIG. 6G-2 shows a list of brands that can facilitate the selected service. FIG. 6G-3 shows a list of 9 hair shades that a user can select. FIG. 6G-4 shows a list of percentages of gray that a user can select. FIG. 6G-5 shows a list of hair textures that a user can select. When a different service is selected, the mobile application 400 may prompt a user to input additional attributes of their hair condition, e.g., hair porosity and hair tone.

The current hair condition may be a user's natural hair or unnatural hair that has been previously treated. In some embodiments, the current hair condition is determined automatically based on an image of hair by the machine-learning model described above. The interface merely shows the determination made by the machine-learning model. A user can make changes if they disagree with the determination by the machine-learning model. Such changes may be collected by the mobile application 400 and be further used as positive or negative training examples to retrain or finetune the machine-learning model.

FIGS. 6H-1 through 6H-2 illustrate example interfaces for a user to input a desired hair condition. FIG. 6H-1 shows a list of hair shades that a user can select. FIG. 6H-2 shows a list of hair tones that a user can select.

After receiving the current hair condition, desired hair condition, and a preferred brand, the mobile application is configured to determine a hair color formulation. FIG. 6H-3 illustrates an example interface showing the determined hair color formulation based on the user input of the current hair condition and desired hair condition, where the current hair condition may be input as an image of the current hair, or values of attributes that characterize the current hair condition. As illustrated, the hair color formulation includes a first hair coloring product 7/0 and a second hair coloring product 7/71, and their ratio 50%/50% (or 1:1). In addition, the formulation also includes instructions for mixing the two hair color products with 6% or 20 volume developer, which is used for gray coverage.

When a different hair coloring service is selected, the formulation may include adding different ingredients or solutions to the coloring products. For example, in some cases, GOLD is to be added to the formula for porosity, and the coloring products and GOLD are to be mixed with processing solution. “GOLD” refers to a warm tonal quality that can be added to various shades of hair color. A processing solution is a liquid that is mixed with a hair color product or lightening agent to activate it and facilitate the coloring process.

Embodiments described herein may be able to transform the hair color industry by providing a sophisticated color matching and recommendation system. The color matching and recommendation system may be implemented as a mobile application. The mobile application is able to generate precise ratios of different shades from one hair color brand to create a matching shade in another brand. This feature operates without the need for a physical mixing device, as it accurately guides users on mixing and weighing the colors to achieve the desired outcome.

One aspect of the embodiments is its broad consumer reach. Not only is it useful for professional use in salons and by hair stylists, but it is also useful for consumers. By leveraging their mobile devices, users can analyze their current hair color using the mobile device's camera function. In some embodiments, the mobile application employs artificial intelligence (AI) and/or machine-learning (ML) models to determine the most suitable hair color and shade available in retail stores or for online purchases. The AI and/or ML models take into account professional and over-the-counter hair color brands without limitation, ensuring a wide range of options. The AI machine learning component of the application is trained to cater to a diverse audience, including consumers, hairstylists, educational institutions, salons, and retail markets. Its objective is not only to streamline the hair coloring process but also to set a new standard in personalized hair color recommendations, with the broader vision of transforming the future of the hair color industry.

In some embodiments, the mobile application is also able to read the user's skin tone to suggest hair colors that complement the user's cool or warmer undertones. The mobile application is also able to evaluate natural hair level, percentage of grey, hair condition, skin tone, and face shape to provide personalized hair color advice.

In some embodiments, the mobile application may have AI/ML models downloaded from a server. Alternatively, the mobile application is able to communicate with a server that has access to AI/ML models. The mobile application may send an image to the server and cause the server to execute the AI/ML models based on the image. A platform may include the server that trains and/or deploys AI/ML models, mobile applications of users, and brands' systems. The platform facilitates the collection, saving, transmitting, and storing of data for a range of stakeholders, including customers, hairstylists, salons, and brands.

### Computing Machine Architecture

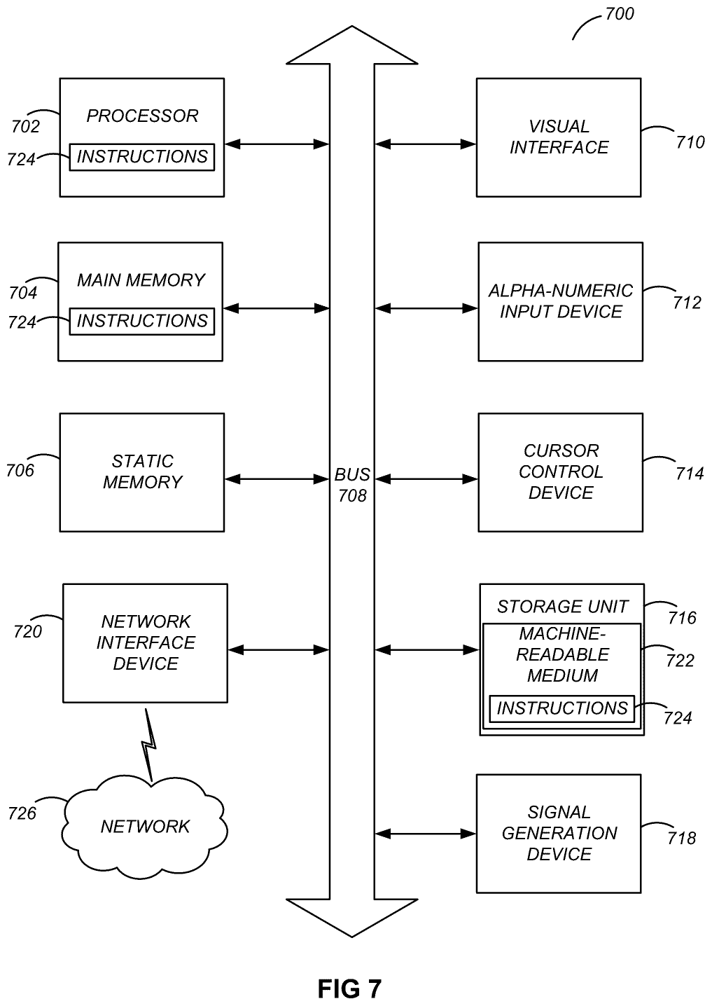

As described above, given that each of the customer client device 110, hairstylist client device 120, retailer client device 130, online system 140, and/or the third-party system 150 may include one or more computer systems, an example computer system is discussed below with respect to FIG. 7.

FIG. 7 is a block diagram illustrating components of an example machine able to read instructions from a machine-readable medium and execute them in a processor (or controller). Specifically, FIG. 7 shows a diagrammatic representation of a machine in the example form of a computer system 700 within which program code (e.g., software) for causing the machine to perform any one or more of the methodologies discussed herein may be executed. The program code may be comprised of instructions 724 executable by one or more processors 702. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 724 (sequential or otherwise) that specify actions to be taken by that machine. Further, while only a single machine is illustrated, the term “machine” shall also be taken to include any collection of machines that individually or jointly execute instructions to perform any one or more of the methodologies discussed herein.

The example computer system 700 includes a processor 702 (e.g., a central processing unit (CPU), a graphics processing unit (GPU), a digital signal processor (DSP), one or more application-specific integrated circuits (ASICs), one or more radio-frequency integrated circuits (RFICs), or any combination of these), a main memory 704, and a static memory 706, which are configured to communicate with each other via a bus 708. The computer system 700 may further include a visual display interface 710. The visual interface may include a software driver that enables displaying user interfaces on a screen (or display). The visual interface may display user interfaces directly (e.g., on the screen) or indirectly on a surface, window, or the like (e.g., via a visual projection unit). For ease of discussion, the visual interface may be described as a screen. The visual interface 710 may include or may interface with a touch-enabled screen. The computer system 700 may also include an alphanumeric input device 712 (e.g., a keyboard or touch screen keyboard), a cursor control device 714 (e.g., a mouse, a trackball, a joystick, a motion sensor, or other pointing instrument), a storage unit 716, a signal generation device 718 (e.g., a speaker), and a network interface device 720, which also are configured to communicate via the bus 708.

The storage unit 716 includes a machine-readable medium 722 on which is stored instructions 724 (e.g., software) embodying any one or more of the methodologies or functions described herein. The instructions 724 (e.g., software) may also reside, completely or at least partially, within the main memory 704 or within the processor 702 (e.g., within a processor's cache memory) during execution thereof by the computer system 700, the main memory 704 and the processor 702 also constituting machine-readable media. The instructions 724 (e.g., software) may be transmitted or received over a network 726 via the network interface device 720.

While machine-readable medium 722 is shown in an example embodiment to be a single medium, the term “machine-readable medium” should be taken to include a single medium or multiple media (e.g., a centralized or distributed database, or associated caches and servers) able to store instructions (e.g., instructions 724). The term “machine-readable medium” shall also be taken to include any medium that is capable of storing instructions (e.g., instructions 724) for execution by the machine and that causes the machine to perform any one or more of the methodologies disclosed herein. The term “machine-readable medium” includes, but not be limited to, data repositories in the form of solid-state memories, optical media, and magnetic media.

### ADDITIONAL CONSIDERATIONS

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium, which include any type of tangible media suitable for storing electronic instructions and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
maintaining a database storing information about hair coloring products from a plurality of brands;
receiving input data from a client device, the input data comprising (1) an image of current hair and (2) a desired hair condition after applying one or more color products of at least one of the plurality of brands;
accessing a machine-learning model trained to output values of one or more attributes that characterize hair conditions based on images of hair, the one or more attributes comprising at least a shade of hair and a tone of hair;
applying the machine-learning model to the image of hair to output values of the one or more attributes that characterize the current hair condition;
applying a decision tree based model to the values of the one or more attributes that characterize the current hair condition and the desired hair condition to output a hair color treatment that is to be applied to the current hair, the hair color treatment causing the current hair to transition from the current hair condition to the desired hair condition;
identifying a hair coloring formulation based on the hair color treatment, wherein the hair coloring formulation includes one or more hair coloring products from at least one of the plurality of brands, along with a ratio between the one or more hair coloring products, and a time period for which a mixture of the one or more hair coloring products is to be applied to the hair to cause the hair to transition from the current condition to the desired hair condition; and
causing the hair coloring formulation to be presented on the client device.

2. The method of claim 1, wherein the hair color treatment includes a level of shade indicating how much a shade of the current hair needs to be darkened or lightened.

3. The method of claim 1, wherein the hair color treatment includes a level of tone indicating how much a tone of the current hair needs to be changed.

4. The method of claim 1, wherein the input data further includes selecting a brand from the plurality of brands, and the one or more coloring products are identified from the selected brand.

5. The method of claim 1, further comprising translating one or more hair coloring products of a first brand to one or more hair coloring products of a second brand that provide a same level of coloring treatment.

6. The method of claim 1, further comprising:
receiving a user feedback indicating whether the output of the machine-learning model is accurate, and
using the output of the machine-learning model as an additional positive or negative example to retrain the machine-learning model.

7. The method of claim 1, wherein the decision tree based model is trained using before and after treatment hair condition pairs labeled with levels of hair color treatment.

8. The method of claim 7, further comprising:
receiving a user feedback indicating whether the output of the decision tree based model is accurate, and
using the output of the decision tree based model as an additional positive or negative example to retrain the decision tree based model.

9. A computer program product comprising a non-transitory computer readable storage medium having instructions encoded thereon that, when executed by a processor, cause the processor to:
maintain a database storing information about hair coloring products from a plurality of brands;
receive input data from a client device, the input data comprising (1) an image of current hair and (2) a desired hair condition after applying one or more color products of at least one of the plurality of brands;
access a machine-learning model trained to output values of one or more attributes that characterize hair conditions based on images of hair, the one or more attributes comprising at least a shade of hair and a tone of hair;
apply the machine-learning model to the image of hair to output values of the one or more attributes that characterize the current hair condition;
apply a decision tree based model to the values of the one or more attributes that characterize the current hair condition and the desired hair condition to output a hair color treatment that is to be applied to the current hair, the hair color treatment causing the current hair to transition from the current hair condition to the desired hair condition;
identify a hair coloring formulation based on the hair color treatment, wherein the hair coloring formulation includes one or more hair coloring products from at least one of the plurality of brands, along with a ratio between the one or more hair coloring products, and a time period for which a mixture of the one or more hair coloring products is to be applied to the hair to cause the hair to transition from the current condition to the desired hair condition; and
cause the hair coloring formulation to be presented on the client device.

10. The computer program product of claim 9, wherein the hair color treatment includes a level of shade indicating how much a shade of the current hair needs to be darkened or lightened.

11. The computer program product of claim 9, wherein the hair color treatment includes a level of tone indicating how much a tone of the current hair needs to be changed.

12. The computer program product of claim 9, wherein the input data further includes selecting a brand from the plurality of brands, and the one or more coloring products are identified from the selected brand.

13. The computer program product of claim 9, further comprising translating one or more hair coloring products of a first brand to one or more hair coloring products of a second brand that provide a same level of coloring treatment.

14. The computer program product of claim 9, further comprising:
receiving a user feedback indicating whether the output of the machine-learning model is accurate, and
using the output of the machine-learning model as an additional positive or negative example to retrain the machine-learning model.

15. The computer program product of claim 9, wherein the decision tree based model is trained using before and after treatment hair condition pairs labeled with levels of hair color treatment.

16. The computer program product of claim 15, further comprising:
receiving a user feedback indicating whether the output of the decision tree based model is accurate, and
using the output of the decision tree based model as an additional positive or negative example to retrain the decision tree based model.

17. A computer system, comprising:
a processor; and
a non-transitory computer readable storage medium having instructions encoded thereon that, when executed by the processor, cause the processor to:
maintain a database storing information about hair coloring products from a plurality of brands;
receive input data from a client device, the input data comprising (1) an image of current hair and (2) a desired hair condition after applying one or more color products of at least one of the plurality of brands;
access a machine-learning model trained to output values of one or more attributes that characterize hair conditions based on images of hair, the one or more attributes comprising at least a shade of hair and a tone of hair;
apply the machine-learning model to the image of hair to output values of the one or more attributes that characterize the current hair condition;
apply a decision tree based model to the values of the one or more attributes that characterize the current hair condition and the desired hair condition to output a hair color treatment that is to be applied to the current hair, the hair color treatment causing the current hair to transition from the current hair condition to the desired hair condition;
identify a hair coloring formulation based on the hair color treatment, wherein the hair coloring formulation includes one or more hair coloring products from at least one of the plurality of brands, along with a ratio between the one or more hair coloring products, and a time period for which a mixture of the one or more hair coloring products is to be applied to the hair to cause the hair to transition from the current condition to the desired hair condition; and
cause the hair coloring formulation to be presented on the client device.

18. The computer system of claim 17, wherein the hair color treatment includes a level of shade indicating how much a shade of the current hair needs to be darkened or lightened.

19. The computer system of claim 17, wherein the hair color treatment includes a level of tone indicating how much a tone of the current hair needs to be changed.

20. The computer system of claim 17, wherein the input data further includes selecting a brand from the plurality of brands, and the one or more coloring products are identified from the selected brand.
